(19) United States
(12) Patent Application Publication
(10) Pub. No.: US 2025/0184675 A1
(43) Pub. Date: Jun. 5, 2025

(54) PROGRAM, CONTROL DEVICE, HEARING AID, COMMUNICATION DEVICE, HEARING AID SYSTEM, AND CONTROL METHOD

(71) Applicant: Sony Group Corporation, Tokyo (JP)

(72) Inventor: Noriaki FUJITA, Tokyo (JP)

(73) Assignee: Sony Group Corporation, Tokyo (JP)

(21) Appl. No.: 18/843,737

(22) PCT Filed: Feb. 7, 2023
(86) PCT No.: PCT/JP2023/003892

§ 371 Date: Sep. 4, 2024

(30) Foreign Application Priority Data
Mar. 16, 2022 (JP) 2022-041498

(51) Int. Cl. H04R 25/00

(52) U.S. Cl. CPC H04R 25/50; H04R 25/554

(57) ABSTRACT

A control device including a processor causes the processor to execute: acquiring a first sound signal; outputting, to a user, the first sound signal and a second sound signal obtained by applying a hearing aid function to the first sound signal at different pieces of timing; acquiring first hearing information of the user for the first sound signal and second hearing information of the user for the second sound signal; and generating output data on wearing of a hearing aid of the user based on the first hearing information and the second hearing information.

### FIELD

The present disclosure relates to a program, a control device, a hearing aid, a communication device, a hearing aid system, and a control method.

### BACKGROUND

When wearing a hearing aid for the first time, a person with a hearing loss may feel annoyed since the hearing aid makes the person to hear sound that has not been heard so far suddenly at a large volume. This is due to a phenomenon in which the brain of the person with a hearing loss is accustomed to a state of a hearing loss and sound amplified by the hearing aid makes the person feel bothered. That is, the person with a hearing loss needs to continue wearing the hearing aid and perform training for improving hearing.

The training is commonly called auditory rehabilitation. The person with a hearing loss has needed to start the training at a sound pressure of 60% to 70% of a target sound pressure set at the start of wearing the hearing aid. The sound pressure needs to be gradually increased over several months to adjust the sound pressure to the target sound pressure. Therefore, the person with a hearing loss has been inconveniently required to visit a hospital or a specialized shop many times.

According to Patent Literature 1, it is known that sound image localization can be achieved by individually optimizing a head related transfer function (HRTF).

### CITATION LIST

### Patent Literature

Patent Literature 1: JP 2015-19360 A

### SUMMARY

### Technical Problem

It is conceivable to virtually perform auditory rehabilitation with reference to Patent Literature 1 above. Unfortunately, there is a problem that appropriate output data to be used for a hearing aid cannot be generated.

The present disclosure has been made in view of the above, and an object thereof is to provide a program, a control device, a hearing aid, a communication device, a hearing aid system, and a control method capable of generating appropriate output data to be used for the hearing aid.

### Solution to Problem

In order to solve the above problems, a program according to the present disclosure is the program to be executed by a control device including a processor, the program causes the processor to execute: acquiring a first sound signal; outputting, to a user, the first sound signal and a second sound signal obtained by applying a hearing aid function to the first sound signal at different pieces of timing; acquiring first hearing information of the user to the first sound signal and second hearing information of the user to the second sound signal; and generating output data on wearing of a hearing aid of the user based on the first hearing information and the second hearing information.

Also, a control device includes a first acquisition unit that acquires a first sound signal; an output unit that outputs, to a user, the first sound signal and a second sound signal obtained by applying a hearing aid function to the first sound signal at different pieces of timing; a second acquisition unit that acquires first hearing information of the user to the first sound signal and second hearing information of the user to the second sound signal; and a generation unit that generates output data on wearing of a hearing aid of the user based on the first hearing information and the second hearing information.

Also, a hearing aid includes: the above control device; a sound collection unit that collects external sound and generates a voice signal; and a signal processing unit that amplifies the voice signal.

Also, a hearing aid includes: the above control device; a sound collection unit that collects external sound and generates a voice signal; and a signal processing unit that amplifies the voice signal.

Also, a hearing aid system includes: a hearing aid allowed to be worn by a user; and a communication device allowed to communicate with the hearing aid, wherein the communication device includes: a first acquisition unit that acquires a first sound signal; an output control unit that causes the hearing aid to output, to the user, the first sound signal and a second sound signal obtained by applying a hearing aid function to the first sound signal at different pieces of timing; a second acquisition unit that acquires first hearing information of the user to the first sound signal and second hearing information of the user to the second sound signal; and a generation unit that generates output data on wearing of a hearing aid of the user based on the first hearing information and the second hearing information.

Also, a control method to be executed by a control device including a processor, the processor execute: acquiring a first sound signal; outputting, to a user, the first sound signal and a second sound signal obtained by applying a hearing aid function to the first sound signal at different pieces of timing; acquiring first hearing information of the user to the first sound signal and second hearing information of the user to the second sound signal; and generating output data on wearing of a hearing aid of the user based on the first hearing information and the second hearing information.

### BRIEF DESCRIPTION OF DRAWINGS

FIG. 1 illustrates a schematic configuration of a hearing aid system according to one embodiment.

FIG. 2 is a block diagram illustrating a functional configuration of the hearing aid system according to one embodiment.

FIG. 3 is a flowchart outlining processing executed by a communication device according to one embodiment.

FIG. 4 illustrates one example of a hearing measurement screen displayed by a display unit according to one embodiment.

FIG. 5 schematically expresses a sound field in a case where an inspection sound signal generated by a processing unit according to one embodiment is reproduced.

FIG. 6 is a flowchart outlining unaided ear threshold measuring processing in FIG. 3.

FIG. 7 is a flowchart outlining wearing time threshold measuring processing in FIG. 3.

FIG. 8 illustrates one example of a hearing measurement result screen displayed by the display unit according to one embodiment.

FIG. 9 is a flowchart outlining hearing aid setting processing executed by a communication device according to one embodiment.

FIG. 10 is a flowchart outlining audiogram output processing executed by the communication device according to one embodiment.

FIG. 11 is a flowchart outlining processing executed by a communication device according to a variation of one embodiment.

### DESCRIPTION OF EMBODIMENTS

Embodiments for conducting the present disclosure will be described in detail below with reference to the drawings. Note that the present disclosure is not limited by the following embodiments. Furthermore, each figure referred to in the following description merely schematically illustrates a shape, a size, and a positional relation to such an extent that the contents of the present disclosure can be understood. That is, the present disclosure is not limited only to the shape, size, and positional relation in each figure. Moreover, in the descriptions of the drawings, the same portions are denoted by the same reference signs. In addition, a hearing aid system including a pair of right and left air conduction hearing aids of an ear hole type will be described as one example of a hearing aid system according to the present disclosure.

### [Outline of Hearing Aid System]

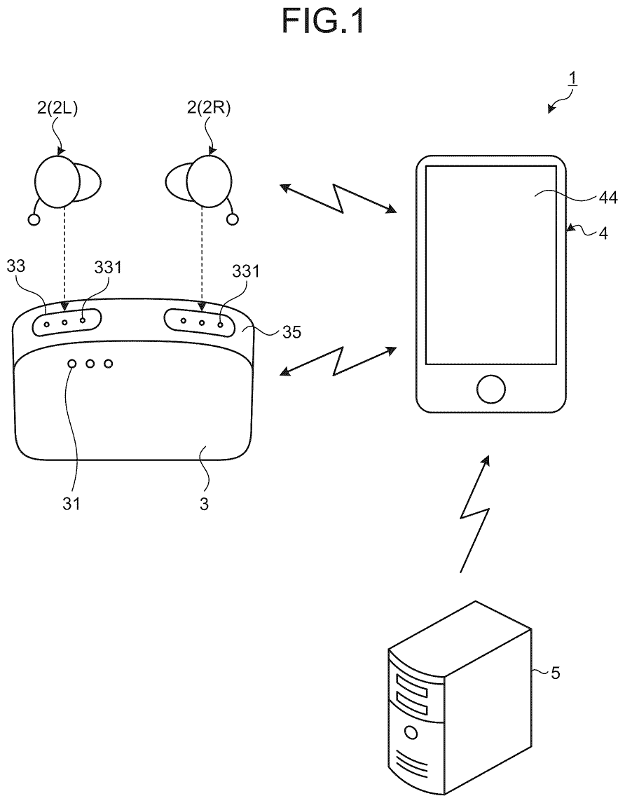

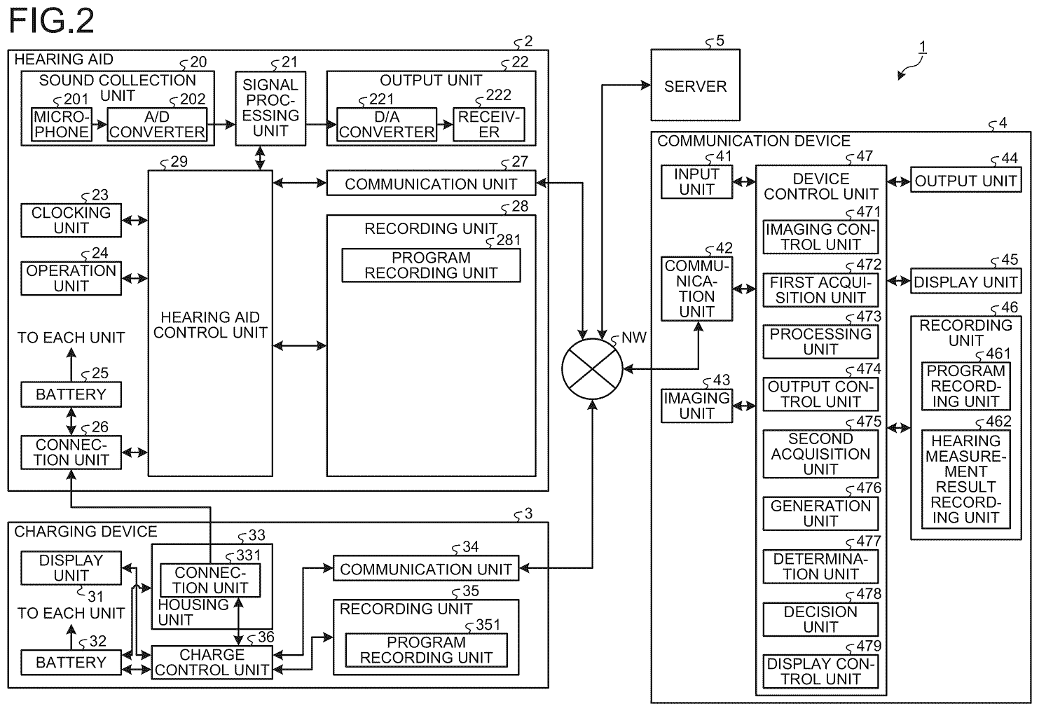

FIG. 1 illustrates a schematic configuration of a hearing aid system according to one embodiment. FIG. 2 is a block diagram illustrating a functional configuration of the hearing aid system according to one embodiment.

A hearing aid system 1 in FIGS. 1 and 2 includes a pair of right and left hearing aids 2, a charging device 3 (charging case), a communication device 4, and a server 5. The charging device 3 houses the hearing aids 2, and charges the hearing aids 2. The communication device 4 includes a mobile phone, and can communicate with at least one of the hearing aids 2 and the charging device 3. The server 5 can communicate with the communication device 4.

Note that, although, in one embodiment, a case of the hearing aids 2 of an air conduction type will be described, this is not a limitation. For example, those of a bone conduction type can be applied. Moreover, although, in one embodiment, a case of the hearing aids 2 of an ear hole type will be described, this is not a limitation. For example, those of an ear hook type, a headphone type, and a pocket type can be applied. In addition, although, in one embodiment, a case of the hearing aids 2 of a binaural type will be described, this is not a limitation. Those of a monaural type in which a hearing aid 2 is worn on one of right and left ears. In the following description, a hearing aid 2 worn on a right ear is referred to as a hearing aid 2R. A hearing aid 2 worn on a left ear is referred to as a hearing aid 2L. When a hearing aid 2 worn on one of right and left ears is noted, the hearing aid 2 is simply referred to and described as a hearing aid 2.

### [Configuration of Hearing Aid]

First, a configuration of a hearing aid 2 will be described.

As illustrated in FIGS. 1 and 2, the hearing aid 2 includes a sound collection unit 20, a signal processing unit 21, an output unit 22, a clocking unit 23, an operation unit 24, a battery 25, a connection unit 26, a communication unit 27, a recording unit 28, and a hearing aid control unit 29.

The sound collection unit 20 includes a microphone 201 and an A/D converter 202. The microphone 201 collects external sound, generates an analog sound signal (acoustic signal), and outputs the analog sound signal to the A/D converter 202. The A/D converter 202 performs A/D conversion processing on the analog sound signal input from the microphone 201, and outputs a digital voice signal to the signal processing unit 21.

The signal processing unit 21 performs predetermined signal processing on the digital sound signal input from the sound collection unit 20, and outputs the digital sound signal to the output unit 22 under the control of the hearing aid control unit 29. Here, the predetermined signal processing includes filtering processing of performing separation for each predetermined frequency on a sound signal, amplification processing of performing amplification in a predetermined amplification amount for each predetermined frequency at which the filtering processing has been performed, noise reduction processing, and howling cancellation processing. The signal processing unit 21 includes a memory and a processor having hardware such as a digital signal processor (DSP).

The output unit 22 includes a D/A converter 221 and a receiver 222. The D/A converter 221 performs D/A conversion processing on the digital sound signal input from the signal processing unit 21, and outputs the digital sound signal to the receiver 222. The receiver 222 outputs output sound corresponding to the analog sound signal input from the D/A converter 221. The receiver 222 includes, for example, a speaker.

The clocking unit 23 clocks date and time, and outputs the clocking result to the hearing aid control unit 29. The clocking unit 23 includes a timing generator and a timer having a clocking function.

The operation unit 24 receives input of an activation signal for activating the hearing aid 2, and outputs the received activation signal to the hearing aid control unit 29. The operation unit 24 includes a push type switch, a button, and a touch panel.

The battery 25 supplies power to each unit constituting the hearing aid 2. The battery 25 includes a rechargeable secondary battery, for example, a lithium-ion battery. The battery 25 is charged by power supplied from the charging device 3 via the connection unit 26.

When the hearing aid 2 is housed in the charging device 3 to be described later, the connection unit 26 is connected to the connection unit of the charging device 3, receives power and various types of information from the charging device 3, and outputs the various types of information to the charging device 3. The connection unit 26 includes a plurality of pins.

The communication unit 27 bidirectionally communicates with the charging device 3 or the communication device 4 via a network NW in accordance with a predetermined communication standard under the control of the hearing aid control unit 29. Here, for example, Wi-Fi (registered trademark) and Bluetooth (registered trademark) are assumed as the predetermined communication standard. The communication unit 27 includes a communication module.

The recording unit 28 records various types of information on the hearing aid 2. The recording unit 28 includes a random access memory (RAM), a read only memory (ROM), and a memory card. The recording unit 28 includes a program recording unit 281 that records a program executed by the hearing aid 2 and various types of data being processed by the hearing aid 2.

The hearing aid control unit 29 controls each unit constituting the hearing aid 2. The hearing aid control unit 29 includes a memory and a processor having hardware such as a central processing unit (CPU) and a DSP. The hearing aid control unit 29 reads and executes a program recorded in the program recording unit 281 in a work area of the memory, and controls each component and the like through the execution of the program performed by the processor, so that the hardware and software cooperate with each other to achieve a functional module matching a predetermined purpose.

### [Configuration of Charging Device]

Next, a configuration of the charging device 3 will be described.

As illustrated in FIGS. 1 and 2, the charging device 3 includes a display unit 31, a battery 32, a housing unit 33, a communication unit 34, a recording unit 35, and a charge control unit 36.

The display unit 31 displays various states related to the hearing aid 2 under the control of the charge control unit 36. For example, the display unit 31 displays information indicating that the hearing aid 2 is being charged and information indicating that various types of information are being received from the communication device 4. The display unit 31 includes a light emitting diode (LED).

The battery 32 supplies power to each unit constituting the hearing aid 2 and the charging device 3 housed in the housing unit 33 via a connection unit 331 provided in the housing unit 33 to be described later. The battery 32 includes a secondary battery, for example, a lithium-ion battery. Note that, in the first embodiment, a power supply circuit that supplies power to the hearing aid 2 by DC/DC conversion may be further provided in addition to the battery 32. In the DC/DC conversion, AC power supplied from the outside is converted into DC power, and then converted into a predetermined voltage.

The housing unit 33 individually stores the right and left hearing aids 2. Furthermore, the connection unit 331 is provided in the housing unit 33. The connection unit 331 can be connected to the connection unit 26 of the hearing aid 2.

When the hearing aid 2 is housed in the housing unit 33, the connection unit 331 is connected to the connection unit 26 of the hearing aid 2, transmits power from the battery 32 and various types of information from the charge control unit 36, receives various types of information from the hearing aid 2, and outputs the information to the charge control unit 36. The connection unit 331 includes a plurality of pins.

The communication unit 34 communicates with the communication device 4 in accordance with a predetermined communication standard via the network NW under the control of the charge control unit 36. The communication unit 34 includes a communication module.

The recording unit 35 includes a program recording unit 351 that records various programs executed by the charging device 3. The recording unit 35 includes a RAM, a ROM, a flash memory, and a memory card.

The charge control unit 36 controls each unit constituting the charging device 3. For example, when the hearing aid 2 is housed in the housing unit 33, the charge control unit 36 supplies power from the battery 32 via the connection unit 331. The charge control unit 36 includes a memory and a processor having hardware such as a CPU or a DSP. The charge control unit 36 reads and executes a program recorded in the program recording unit 351 in a work area of the memory, and controls each component and the like through the execution of the program performed by the processor, so that the hardware and software cooperate with each other to achieve a functional module matching a predetermined purpose.

### [Configuration of Communication Device]

Next, a configuration of the communication device 4 will be described.

As illustrated in FIGS. 1 and 2, the communication device 4 includes an input unit 41, a communication unit 42, an imaging unit 43, an output unit 44, a display unit 45, a recording unit 46, and a device control unit 47.

The input unit 41 receives inputs of various operations from a user, and outputs a signal in accordance with the received operation to the device control unit 47. The input unit 41 includes a switch and a touch panel.

The communication unit 42 communicates with the charging device 3 or the hearing aid 2 via the network NW under the control of the device control unit 47. The communication unit 42 includes a communication module.

The imaging unit 43 generates imaging data by imaging a predetermined subject, and outputs the imaging data to the device control unit 47. The imaging unit 43 includes an optical system and an image sensor. The optical system includes one or a plurality of lenses. The image sensor includes a charge coupled device (CCD) sensor or a complementary metal oxide semiconductor (CMOS) sensor that receives light of a subject image collected by the optical system.

The output unit 44 outputs a volume at a predetermined sound pressure level for each predetermined frequency under the control of the device control unit 47. The output unit 44 includes a speaker.

The display unit 45 displays various types of information on the communication device 4 and information on the hearing aid 2 under the control of the device control unit 47. The display unit 45 includes a liquid crystal display and an organic electroluminescent (EL) display.

The recording unit 46 records various types of information on the communication device 4. The recording unit 46 includes a program recording unit 461 and a hearing measurement result recording unit 462. The program recording unit 461 records various programs executed by the communication device 4. The hearing measurement result recording unit 462 records information on an audiogram, a hearing measurement result, and the like. The recording unit 46 includes a recording medium such as a RAM, a ROM, a flash memory, and a memory card.

The device control unit 47 controls each unit constituting the communication device 4. The device control unit 47 includes a memory and a processor having hardware such as a CPU. The device control unit 47 reads and executes a program recorded in the program recording unit 461 in a work area of the memory, and controls each component and the like through the execution of the program performed by the processor, so that the hardware and software cooperate with each other to achieve a functional module matching a predetermined purpose. Specifically, the device control unit 47 includes an imaging control unit 471, a first acquisition unit 472, a processing unit 473, an output control unit 474, a second acquisition unit 475, a generation unit 476, a determination unit 477, a decision unit 478, and a display control unit 479. Note that, in one embodiment, the device control unit 47 functions as a control device.

The imaging control unit 471 controls imaging of the imaging unit 43. Specifically, the imaging control unit 471 causes the imaging unit 43 to perform imaging and generate imaging data in accordance with an operation of the input unit 41.

The first acquisition unit 472 acquires a head-related transfer function (HRTF) optimized for an ear of the user from the server 5 via the network NW and the communication unit 42.

The processing unit 473 generates an inspection sound signal for measuring a wearing threshold of a hearing level of the user by using the head-related transfer function (HRTF) optimized for the user, which has been acquired by the first acquisition unit 472 from the server 5.

The output control unit 474 transmits the imaging data generated by the imaging unit 43 to the server 5 via the network NW and the communication unit 42. Furthermore, the output control unit 474 outputs the inspection sound signal generated by the processing unit 473 to the hearing aid 2 via the network NW and the communication unit 42, and causes the hearing aid 2 to reproduce sound corresponding to the inspection sound signal.

The second acquisition unit 475 acquires first hearing information of the user for a first sound signal to which the hearing aid 2 does not apply the hearing aid function and second hearing information of the user for a second sound signal to which the hearing aid 2 has applied the hearing aid function, and records the acquired first hearing information and second hearing information in the hearing measurement result recording unit 462.

The generation unit 476 generates output data at the time when the user wears the hearing aid 2 based on the first hearing information and the second hearing information recorded in the hearing measurement result recording unit 462. Specifically, the generation unit 476 generates, as output data, an audiogram based on the first hearing information and the second hearing information. The audiogram is output data at the time when the user wears the hearing aid 2. The first hearing information is a wearing threshold for each frequency recorded in the hearing measurement result recording unit 462. The second hearing information is an unaided ear threshold.

The determination unit 477 determines whether or not measurements for all frequencies at the time when an ear of the user is unaided have been completed. The determination unit 477 determines whether or not the user has performed the measurement through both ears by using hearing aids 2.

The decision unit 478 decides a parameter value for hearing aid adjustment of the hearing aid 2 as a wearing threshold of the hearing aid 2 based on the hearing measurement result generated by the generation unit 476. The decision unit 478 outputs the parameter value for hearing aid adjustment of the hearing aid 2 to the hearing aid 2 via the network NW and the communication unit 42. Furthermore, the decision unit 478 decides a volume of the current frequency output from the hearing aid 2 as a hearing level at the time when the ear of the user is unaided or when the user wears the hearing aid 2.

The display control unit 479 causes the display unit 45 to display an audiogram measurement screen for the user to generate the wearing threshold of the hearing aid 2. Moreover, the display control unit 479 causes the display unit 45 to display an audiogram measurement result.

### [Functional Configuration of Server]

Next, a functional configuration of the server 5 will be described.

The server 5 calculates a head-related transfer function for the user based on imaging data, including an ear of the user, received from the communication device 4 via the network NW by using a learned model in which a head-related transfer function (HRTF) for the ear is output in a case where an image including a video of the ear is input. The server 5 transmits the calculated head-related transfer function to the communication device 4.

The hearing aid system 1 configured as described above can generate appropriate output data to be used for the hearing aid 2. Specifically, a doctor or an expert has needed to appropriately adjust and set a sound pressure to a level which a person with a hearing loss can barely tolerate at the time when the person starts to wear the hearing aid 2. An index of the adjustment is measurement of the wearing threshold of the hearing aid 2. Since a dedicated place and device are necessary for measuring the wearing threshold of the hearing aid 2, the person with a hearing loss has been inconveniently required to visit a hospital or a specialized shop many times. In contrast, the hearing aid system 1 can generate appropriate output data to be used for the hearing aid 2 by virtually reproducing an environment for measuring the wearing threshold in a pseudo manner using processing performed by the communication device 4 to be described later. As a result, the person with a hearing loss can easily obtain the wearing threshold since the person does not need to visit the hospital or the specialized shop many times.

### [Processing of Communication Device]

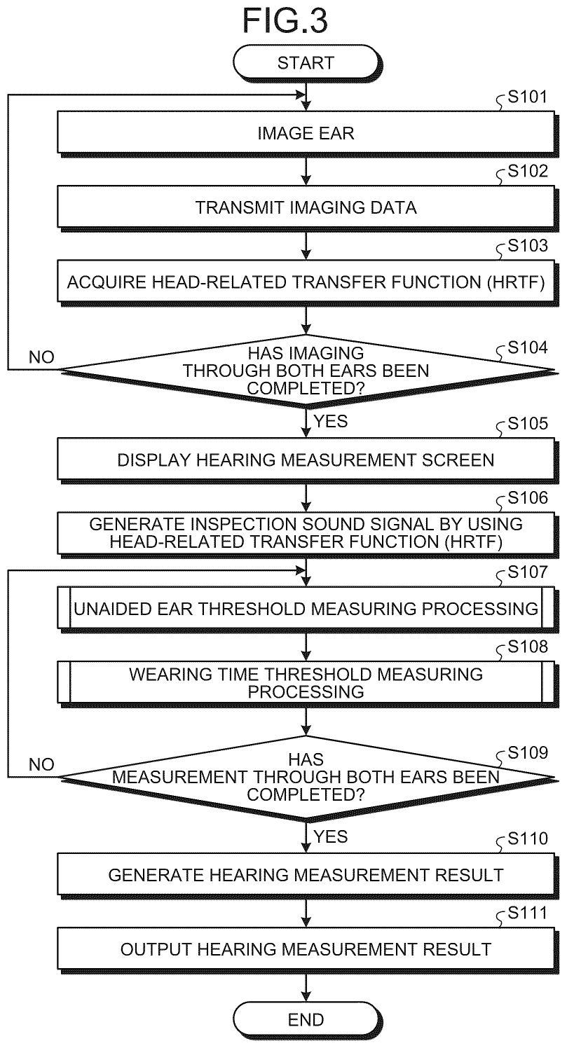

Next, processing performed by the communication device 4 will be described. FIG. 3 is a flowchart outlining the processing executed by the communication device 4.

As illustrated in FIG. 3, the imaging control unit 471 causes the imaging unit 43 to image an ear of the user in accordance with an operation from the input unit 41 (Step S101). In this case, the imaging control unit 471 may detect the ear of the user by performing known template matching on captured images corresponding to pieces of imaging data sequentially generated by the imaging unit 43, and cause the output unit 44 to output voice for guiding the ear of the user to be included in an imaging region of the imaging unit 43 based on the detection result.

Subsequently, the output control unit 474 transmits the imaging data generated by the imaging unit 43 to the server 5 via the communication unit 42 (Step S102).

Thereafter, the first acquisition unit 472 acquires a head-related transfer function (HRTF) optimized for the ear of the user from the server 5 via the communication unit 42 (Step S103).

Subsequently, the determination unit 477 determines whether or not the user has completed imaging through both the ears (Step S104). Specifically, the determination unit 477 determines whether or not head-related transfer functions (HRTFs) for both the ears are recorded in the hearing measurement result recording unit 462. When the head-related transfer functions (HRTFs) for both the ears are recorded in the hearing measurement result recording unit 462, the determination unit 477 determines that the user has completed the imaging through both the ears. When the determination unit 477 determines that the imaging through both the ears has been completed (Step S104: Yes), the communication device 4 proceeds to Step S105 to be described later. In contrast, when the determination unit 477 determines that the user has not completed the imaging through both the ears (Step S104: No), the communication device 4 returns to Step S101 above.

Thereafter, the display control unit 479 causes the display unit 45 to display an audiogram measurement screen for the user to generate the wearing threshold of the hearing aid 2 (Step S105). In this case, the display control unit 479 causes the display unit 45 to display a message instructing the user to wear the hearing aid 2 together with a hearing measurement screen. Of course, the display control unit 479 may cause the output unit 44 to output voice instructing the user to wear the hearing aid 2.

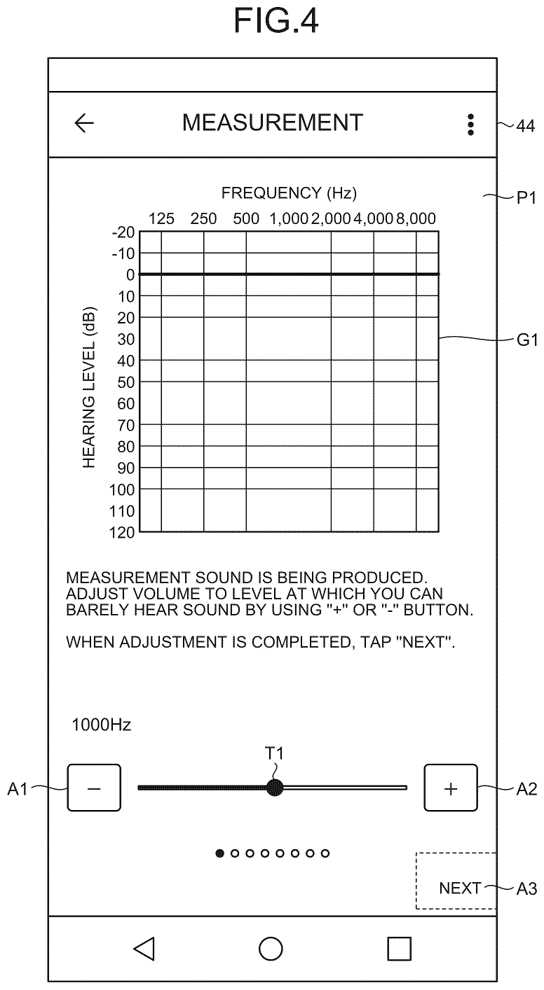

FIG. 4 illustrates one example of a hearing measurement screen displayed by the display unit 45. A hearing measurement screen P1 in FIG. 4 includes a measurement graph G1, an icon A1, an icon A2, and an icon A3. The measurement graph G1 indicates the states of a hearing level of the user and a frequency. The icons A1 and A2 receive input of an adjustment signal that gives an instruction to adjust an amplification factor for a sound signal, having a predetermined frequency, output from the hearing aid 2. The icon A3 receives input of a setting signal that gives an instruction to set the next frequency. Moreover, the hearing measurement screen P1 includes a slide bar T1 that receives input of an adjustment signal that gives an instruction to adjust an amplification factor for a sound signal, having a predetermined frequency, output from the hearing aid 2. The user measures his/her hearing level at the time of an unaided ear and at the time when the user wears the hearing aid 2 for each frequency while operating the icons A1 to A3 and the slide bar T1 displayed by the display unit 45.

After Step S105, the processing unit 473 generates an inspection sound signal for measuring a wearing threshold of a hearing level of the user by using the head-related transfer function (HRTF) optimized for the user, which has been acquired by the first acquisition unit 472 from the server 5 (Step S106). Specifically, when the receiver 222 of the hearing aid 2 performs acoustic reproduction, the processing unit 473 generates an inspection sound signal in which a head-related transfer function is convolved with a sound signal for measuring a wearing threshold. The head-related transfer function is used so that a sound image is heard so as to be localized at a virtual sound image fixed position assumed for the receiver 222. For example, the processing unit 473 generates a signal based on MPEG-H 3D Audio as an inspection sound signal by using a head-related transfer function (HRTF) acquired by the first acquisition unit 472 from the server 5 and optimized for the user.

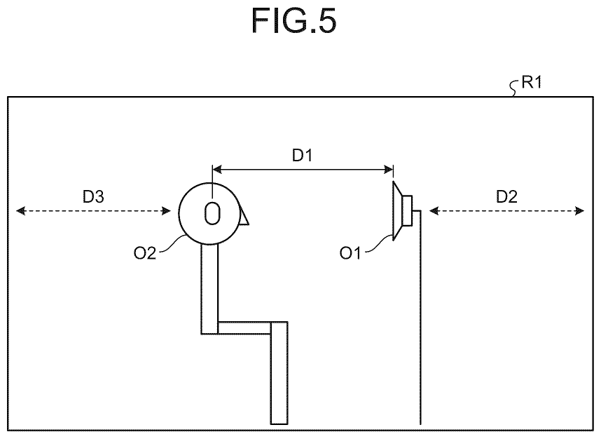

FIG. 5 schematically expresses a sound field in a case where the inspection sound signal generated by the processing unit 473 is reproduced. In sound field space R1 having a predetermined area (e.g., 2 m*3 m) in FIG. 5, a speaker sound source O1 has the same height as that of the center of a head O2 of the user, and a distance D1 to the head O2 is set to a predetermined distance, for example, 0.5 to 1.0 m. Moreover, a distance D2 from one of four end surfaces forming the sound field space R1 to the speaker sound source O1 and a distance D3 from another one of the four end surfaces to the head O2 are set as approximately 1 m. This enables the user to virtually measure hearing from the speaker sound source O1 in the virtual sound field space R1.

After Step S106, the communication device 4 executes unaided ear threshold measuring processing for virtually measuring a wearing threshold of a hearing level of the user in a state in which an ear of the user is unaided (Step S107). Here, in the state in which an ear of the user is virtually unaided, a hearing aid function of the hearing aid 2 is not applied. That is, in the state in which the hearing aid function of the hearing aid 2 is not applied, a voice signal is amplified by the signal processing unit 21 of the hearing aid 2 at an amplification factor of one, and an output sound is output to the output unit 22. After Step S107, the communication device 4 proceeds to Step S108 to be described later.

### [Outline of Unaided Ear Threshold Measuring Processing]

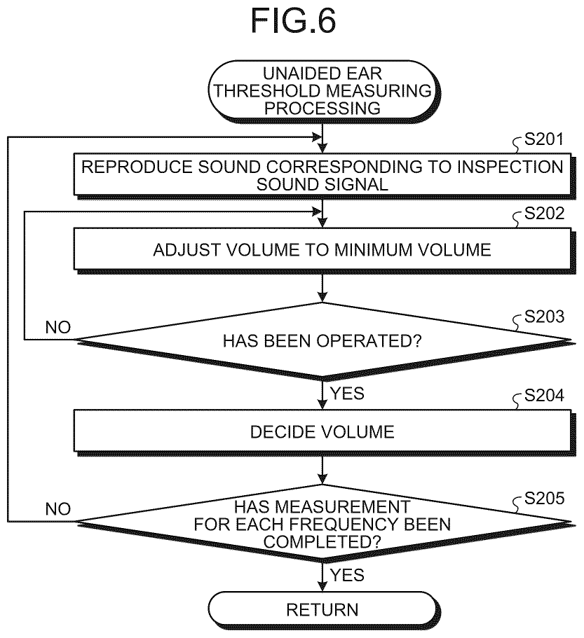

FIG. 6 is a flowchart outlining the unaided ear threshold measuring processing in Step S107 in FIG. 3.

As illustrated in FIG. 6, first, the output control unit 474 outputs an inspection sound signal generated by the processing unit 473 to the hearing aid 2, and causes the hearing aid 2 to reproduce sound corresponding to the inspection sound signal (Step S201). In this case, the hearing aid control unit 29 causes the signal processing unit 21 to amplify the inspection sound signal input from the communication device 4 via the communication unit 27 at a predetermined amplification factor, an amplification factor at which the hearing aid function of the hearing aid 2 is not applied, for example, one time, and to output the inspection sound signal to the output unit 22. This enables the user to hear the output sound in a virtual state of an unaided ear even when the user wears the hearing aid 2.

Subsequently, the output control unit 474 adjusts a volume of a sound signal, having a predetermined frequency, output from the hearing aid 2 to the minimum volume (Step S202). Specifically, the output control unit 474 outputs, to the hearing aid 2, an instruction signal to reduce the volume of a sound signal, having a predetermined frequency, output from the output unit 22 of the hearing aid 2 with time. This causes the hearing aid 2 to gradually reduce an output sound corresponding to a currently reproduced sound signal of a frequency.

Thereafter, the determination unit 477 determines whether or not the icon A3 on the hearing measurement screen P1 displayed by the display unit 45 has been operated via the input unit 41 (Step S203). When the determination unit 477 determines that the icon A3 on the hearing measurement screen P1 displayed by the display unit 45 has been operated via the input unit 41 (Step S203: Yes), the communication device 4 proceeds to Step S204 to be described later. In contrast, When the determination unit 477 determines that the icon A3 on the hearing measurement screen P1 displayed by the display unit 45 has not been operated via the input unit 41 (Step S203: No), the communication device 4 returns to Step S202 above.

In Step S204, the decision unit 478 decides a volume of the current frequency output from the hearing aid 2 as a hearing level (first hearing information) at the time when the ear of the user is unaided. The decision unit 478 records the hearing level at the time of the unaided ear in the hearing measurement result recording unit 462 in association with the current frequency.

Subsequently, the determination unit 477 determines whether or not measurements for all the frequencies at the time when an ear of the user is unaided have been completed (Step S205). For example, the determination unit 477 determines whether or not measurement of a wearing threshold of a hearing level of the user has been completed in a state of the unaided ear at each of 250 Hz, 500 Hz, 1000 Hz, 2000 Hz, and 4000 Hz. When the determination unit 477 determines that measurements for all the frequencies have been completed (Step S205: Yes), the communication device 4 returns to the main routine in FIG. 3, and proceeds to Step S108. In this case, the first acquisition unit 472 acquires measurement results for all the frequencies at the time when the ear of the user is unaided as the first hearing information on the user for the first sound signal. In contrast, when the determination unit 477 determines that measurements for all the frequencies have not been completed (Step S205: No), the communication device 4 returns to Step S201 above, and reproduces voice of the next frequency.

In Step S108, the communication device 4 executes wearing time threshold measuring processing for measuring a wearing threshold of a hearing level of the user in a state in which the hearing aid function of the hearing aid 2 is applied. After Step S108, the communication device 4 proceeds to Step S109 to be described later.

### [Outline of Wearing Time Threshold Measuring Processing]

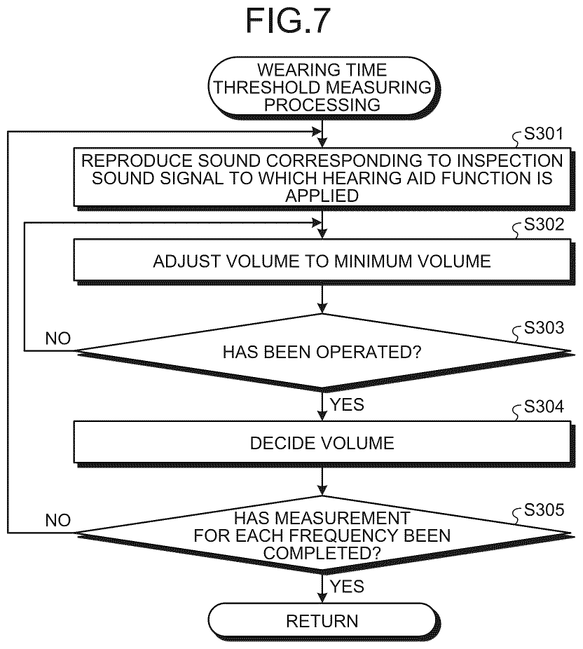

FIG. 7 is a flowchart outlining the wearing time threshold measuring processing in Step S108 in FIG. 3.

As illustrated in FIG. 7, the output control unit 474 outputs an inspection sound signal generated by the processing unit 473 to the hearing aid 2, and causes the hearing aid 2 to reproduce sound corresponding to the inspection sound signal to which the hearing aid function is applied (Step S301). In this case, the hearing aid control unit 29 causes the signal processing unit 21 to amplify the inspection sound signal input from the communication device 4 via the communication unit 27 at a predetermined amplification factor, an amplification factor at which the hearing aid function of the hearing aid 2 is applied, for example, an amplification factor of one or more times, and to output the inspection sound signal to the output unit 22. This enables the user to hear an output sound in a state in which the user wears the hearing aid 2.

Subsequently, the output control unit 474 adjusts a volume of a sound signal, having a predetermined frequency, output from the hearing aid 2 to the minimum volume (Step S302). Specifically, the output control unit 474 outputs, to the hearing aid 2, an instruction signal to reduce the volume of a sound signal, having a predetermined frequency, output from the output unit 22 of the hearing aid 2 with time. This causes the hearing aid 2 to gradually reduce an output sound corresponding to a currently reproduced sound signal of a frequency.

Thereafter, the determination unit 477 determines whether or not the icon A3 on the hearing measurement screen P1 displayed by the display unit 45 has been operated via the input unit 41 (Step S303). When the determination unit 477 determines that the icon A3 on the hearing measurement screen P1 displayed by the display unit 45 has been operated via the input unit 41 (Step S303: Yes), the communication device 4 proceeds to Step S304 to be described later. In contrast, when the determination unit 477 determines that the icon A3 on the hearing measurement screen P1 displayed by the display unit 45 has not been operated via the input unit 41 (Step S303: No), the communication device 4 returns to Step S302 above.

In Step S304, the decision unit 478 decides a volume of the current frequency output from the hearing aid 2 as a hearing level (second hearing information) at the time when the ear of the user is unaided. The decision unit 478 records the hearing level at the time of the unaided ear in the hearing measurement result recording unit 462 in association with the current frequency.

Subsequently, the determination unit 477 determines whether or not measurements for all the frequencies at the time when an ear of the user is unaided have been completed (Step S305). For example, the determination unit 477 determines whether or not measurement of a wearing threshold of a hearing level of the user has been completed in a state of the unaided ear at each of 250 Hz, 500 Hz, 1000 Hz, 2000 Hz, and 4000 Hz. When the determination unit 477 determines that measurements for all the frequencies have been completed (Step S305: Yes), the communication device 4 returns to the main routine in FIG. 3, and proceeds to Step S109. In this case, the first acquisition unit 472 acquires measurement results for all the frequencies as the second hearing information on the user for the first sound signal at the time when the hearing aid function of the hearing aid 2 is applied. In contrast, when the determination unit 477 determines that measurements for all the frequencies have not been completed (Step S305: No), the communication device 4 returns to Step S301 above, and reproduces voice of the next frequency.

Returning to FIG. 3, the description of Step S109 and subsequent steps will be continued.

In Step S109, the determination unit 477 determines whether or not the user has completed measurement through both the ears by using hearing aids 2. Specifically, the determination unit 477 determines whether or not a threshold at a wearing time in a state in which the hearing aids 2 are worn on both the ears is recorded in the hearing measurement result recording unit 462. When the threshold at a wearing time in a state in which the hearing aids 2 are worn on both the ears is not recorded in the hearing measurement result recording unit 462, the determination unit 477 determines that the user has not completed the measurement through both the ears by using hearing aids 2. When the determination unit 477 determines that the user has performed measurement through both the ears by using the hearing aids 2 (Step S109: Yes), the communication device 4 proceeds to Step S110 to be described later. In contrast, when the determination unit 477 determines that the user has not completed the measurement through both the ears by using the hearing aids 2 (Step S109: No), the communication device 4 returns to Step S107 above.

In Step S110, the generation unit 476 generates a hearing measurement result as output data based on a hearing level B1 (first hearing information) and a hearing level B2 (second hearing information). The hearing level B1 is a wearing threshold for each frequency recorded in the hearing measurement result recording unit 462. The hearing level B2 is an unaided ear threshold.

Subsequently, the display control unit 479 outputs the hearing measurement result generated by the generation unit 476 to the display unit 45 or the hearing aid 2 (Step S111). After Step S111, the communication device 4 ends the processing.

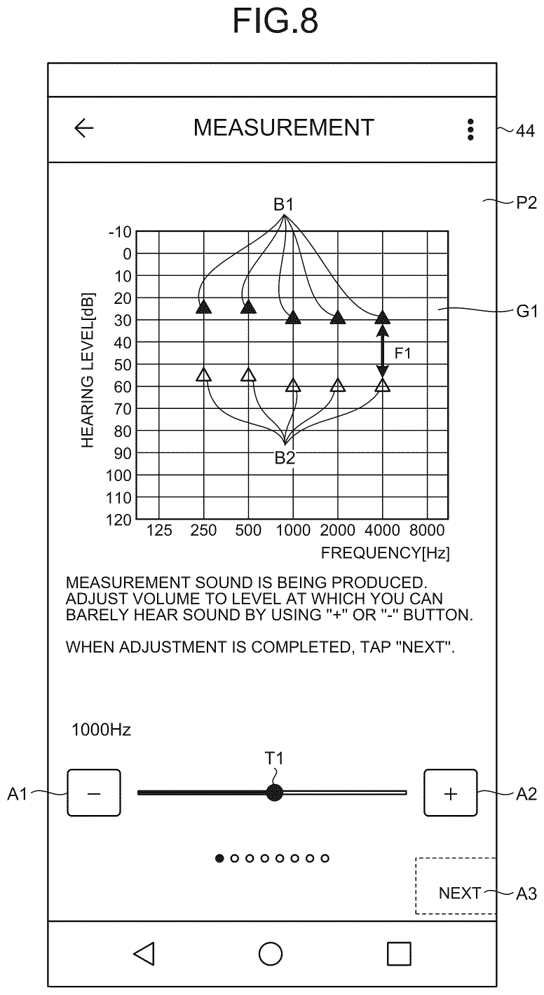

FIG. 8 illustrates one example of a hearing measurement result screen displayed by the display unit 45. The measurement graph G1 on a hearing measurement result screen P2 in FIG. 8 includes, for each frequency, a hearing level B1 (first hearing information) and a hearing level B2 (second hearing information). The hearing level B1 is a wearing threshold. The hearing level B2 is an unaided ear threshold. The hearing level B1, which is a wearing threshold, indicates a wearing threshold of the user in measurement at a wearing time in a case where the hearing aid function of the hearing aid 2 is applied. The hearing level B2, which is an unaided ear threshold, indicates an unaided ear threshold of the user in measurement at the time of a virtual unaided ear in a case where the hearing aid function of the hearing aid 2 is not applied. Furthermore, a functional gain F1 is a difference between the hearing level B1 and the hearing level B2. The hearing level B1 is a wearing threshold for each frequency. The hearing level B2 is an unaided ear threshold. This enables the user to intuitively grasp his/her hearing level by checking the measurement graph G1 on the hearing measurement result screen P2.

### [Hearing Aid Setting Processing]

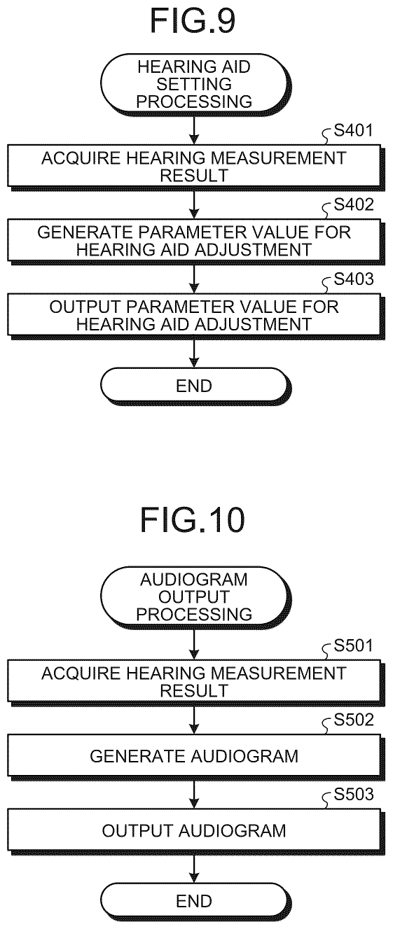

Next, hearing aid setting processing executed by the communication device 4 will be described. FIG. 9 is a flowchart outlining the hearing aid setting processing executed by the communication device 4. Note that the communication device 4 performs the processing in one or more of a case where an instruction signal for setting a parameter value for hearing aid adjustment is input from the input unit 41 to the hearing aid 2, a case where the above-described hearing measurement result of the user is obtained, and a case where a request signal for requesting a parameter value for hearing aid adjustment is received from the hearing aid 2 or the charging device 3.

As illustrated in FIG. 9, first, the decision unit 478 acquires a hearing measurement result generated by the generation unit 476 (Step S401). The hearing measurement result is based on the hearing level B1 (first hearing information) and the hearing level B2 (second hearing information). The hearing level B1 is a wearing threshold for each frequency recorded in the hearing measurement result recording unit 462. The hearing level B2 is an unaided ear threshold.

Subsequently, the decision unit 478 generates a parameter value for hearing aid adjustment of the hearing aid 2 based on the hearing measurement result acquired from the hearing measurement result recording unit 462 (Step S402). Specifically, the decision unit 478 first calculates the functional gain F1 (e.g., see FIG. 8 above) for each frequency. Subsequently, the decision unit 478 decides whether or not the functional gain F1 is equal to or greater than a predetermined value for each frequency. The decision unit 478 decides a value for adjusting a gain of the functional gain F1 having a frequency that is not equal to or greater than the predetermined value. The decision unit 478 generates the decided value as a parameter value for hearing aid adjustment of the hearing aid 2.

Thereafter, the decision unit 478 outputs the parameter value for hearing aid adjustment of the hearing aid 2 to the hearing aid 2 via the communication unit 42 (Step S403). This enables the hearing aid 2 to set a parameter value for hearing aid adjustment in which a wearing threshold of the user is set. After Step S403, the communication device 4 ends the processing.

### [Audiogram Output Processing]

Next, audiogram output processing executed by the communication device 4 will be described. FIG. 10 is a flowchart outlining the audiogram output processing executed by the communication device 4. Note that the communication device 4 performs the processing in one or more of a case where the input unit 41 inputs an instruction signal for giving an instruction to display an audiogram, a case where the above-described hearing measurement result of the user is obtained, and a case where a display instruction signal for causing the display unit 45 to perform display is received from the hearing aid 2 or the charging device 3.

As illustrated in FIG. 10, the generation unit 476 acquires a hearing measurement result based on a hearing level B1 (first hearing information) and a hearing level B2 (second hearing information) (Step S501). The hearing level B1 is a wearing threshold for each frequency recorded in the hearing measurement result recording unit 462. The hearing level B2 is an unaided ear threshold.

Subsequently, the generation unit 476 generates an audiogram based on the hearing measurement result acquired from the hearing measurement result recording unit 462 (Step S502). The audiogram is output data at the time when the user wears the hearing aid 2.

Thereafter, the display control unit 479 outputs the hearing measurement result generated by the generation unit 476 to the display unit 45 (Step S503). This enables the user to grasp his/her hearing level for each frequency by checking the audiogram displayed by the display unit 45. After Step S503, the communication device 4 ends the processing.

According to one embodiment described above, the generation unit 476 generates output data based on the first hearing information of the user for the first sound signal acquired by the second acquisition unit 475 and the second hearing information of the user for the second sound signal to which the hearing aid 2 has applied the hearing aid function, so that appropriate output data to be used for the hearing aid 2 can be generated.

Furthermore, according to one embodiment, the generation unit 476 generates, as output data, an audiogram at the time when the user wears the hearing aid 2, so that the user can start to use the hearing aid 2 in an appropriate state, and obtain a parameter for hearing aid adjustment for auditory rehabilitation by himself/herself.

Furthermore, according to one embodiment, the processing unit 473 generates an inspection sound signal for measuring a wearing threshold of a hearing level of the user by using a head-related transfer function (HRTF), optimized for the user, acquired by the first acquisition unit 472 from the server 5, so that the user does not need to go to an inspection facility for hearing measurement, and the user himself/herself can perform measurement for an audiogram of the hearing aid 2 anywhere.

Furthermore, according to one embodiment, the communication device 4 generates an audiogram suitable for the user, so that the audiogram can be measured regardless of the type of the hearing aid 2.

Note that, although, in one embodiment, the device control unit 47 is provided with the functions of the imaging control unit 471, the first acquisition unit 472, the processing unit 473, the output control unit 474, the second acquisition unit 475, the generation unit 476, the determination unit 477, the decision unit 478, and the display control unit 479, this is not a limitation. The hearing aid control unit 29 may be provided with the functions of the imaging control unit 471, the first acquisition unit 472, the processing unit 473, the output control unit 474, the second acquisition unit 475, the generation unit 476, the determination unit 477, the decision unit 478, and the display control unit 479, and caused to function as a control device of the present disclosure.

Furthermore, in one embodiment, the charge control unit 36 may be provided with the functions of the imaging control unit 471, the first acquisition unit 472, the processing unit 473, the output control unit 474, the second acquisition unit 475, the generation unit 476, the determination unit 477, the decision unit 478, and the display control unit 479, and caused to function as a control device of the present disclosure.

Furthermore, although, in one embodiment, the communication device 4 serves for both the ears of the user, this is not a limitation. For example, the communication device 4 may serve for one ear.

### (Variation)

Next, a variation of one embodiment of the present disclosure will be described. In one embodiment described above, the communication device 4 measures the hearing of the user by using the hearing aids 2 of a binaural type. In the variation of one embodiment, the communication device 4 measures the hearing of the user by using a hearing aid of a monaural type. Therefore, processing executed by the communication device 4 will be described below. Note that the same configurations as those of the hearing aid system 1 according to one embodiment described above are denoted by the same reference signs to omit detailed descriptions thereof.

### [Processing of Communication Device]

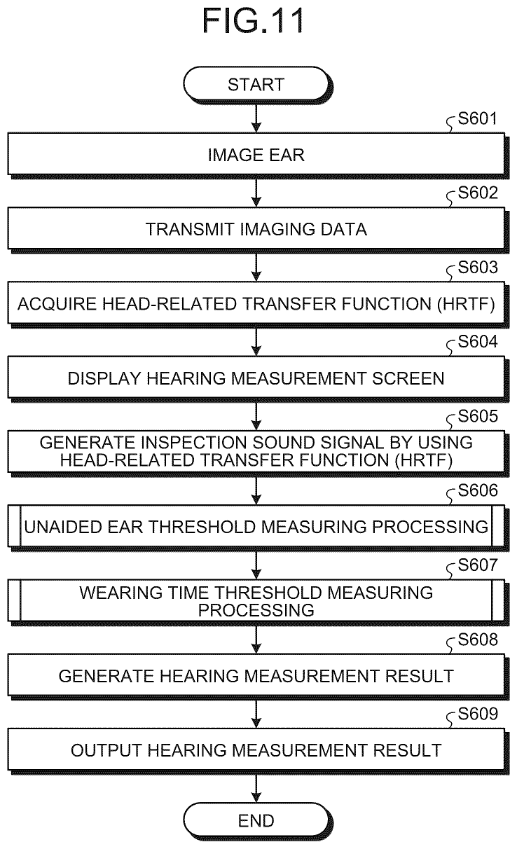

FIG. 11 is a flowchart outlining the processing executed by the communication device 4 according to the variation of one embodiment.

In FIG. 11, Steps S601 to S603 correspond to Steps S101 to S103 in FIG. 3 above, respectively. Steps S604 to S607 correspond to Steps S105 to S108 in FIG. 3 above, respectively. Steps S608 and S609 correspond to Steps S110 and S111 in FIG. 3 above, respectively.

According to the variation of one embodiment described above, effects similar to those in one embodiment described above are exhibited even in a case of the hearing aid 2 of a monaural type.

Note that, although, in the variation of one embodiment, processing performed in a case where the communication device 4 is the hearing aid 2 of a monaural type has been described, this is not a limitation. In a case of the hearing aids 2 of a binaural type, the above-described processing in FIG. 11 may be performed for each of right and left ears.

### (Other Embodiments)

Various inventions can be formed by appropriately combining a plurality of components disclosed in the hearing aid system according to one embodiment of the present disclosure described above. For example, some components may be deleted from all the components described in the hearing aid system according to one embodiment of the present disclosure described above. Moreover, the components described in the hearing aid system according to one embodiment described above may be appropriately combined.

Furthermore, in the hearing aid system according to one embodiment of the present disclosure, the above-described “unit” can be replaced with “means”, “circuit”, or the like. For example, a control unit can be replaced with a control means or a control circuit.

Furthermore, a program to be executed by the hearing aid system according to one embodiment of the present disclosure is provided by being recorded in a computer-readable recording medium, such as a CD-ROM, a flexible disk (FD), a CD-R, a digital versatile disk (DVD), a USB medium, and a flash memory, as file data in an installable format or an executable format.

Furthermore, the program to be executed by the hearing aid system according to one embodiment of the present disclosure may be provided by being stored on a computer connected to a network such as the Internet and downloaded via the network.

Note that, although, in the descriptions of the flowcharts in the present specification, the context of pieces of processing between steps is clearly indicated by using expressions such as “first”, “thereafter”, and “subsequently”, the order of pieces of processing necessary for conducting the present invention is not uniquely defined by such expressions. That is, the order of pieces of processing in the flowcharts described in the present specification can be changed within a range without inconsistency.

Although some of the embodiments of the present application have been described in detail above with reference to the drawings, these are merely examples. The present disclosure can be implemented in other forms to which various modifications and improvements have been made based on knowledge of those skilled in the art, including the forms described in sections of the present disclosure.

Note that the present technology can also have the configurations as follows.

(1)

A program to be executed by a control device including a processor, the program causing the processor to:
acquire a first sound signal;
output, to a user, the first sound signal and a second sound signal obtained by applying a hearing aid function to the first sound signal at different pieces of timing;
acquire first hearing information of the user to the first sound signal and second hearing information of the user to the second sound signal; and
generate output data on wearing of a hearing aid of the user based on the first hearing information and the second hearing information.
   (2)

The program according to (1),
wherein the output data is
an audiogram.
   (3)

The program according to (1) or (2),
wherein the processor
decides a parameter for hearing aid adjustment based on the output data.
   (4)

The program according to (3),
wherein the parameter for hearing aid adjustment is a gain for each frequency.
   (5)

The program according to any one of (1) to (4),
wherein the first sound signal is
an inspection sound signal for the user.
   (6)

The program according to any one of (1) to (5), causing the processor to execute
generating a sound signal in which a head-related transfer function optimized for the user is convolved,
wherein the first sound signal is
a sound signal in which the head-related transfer function is convolved.
   (7)

The program according to any one of (1) to (6),
wherein the first sound signal is
a signal based on MPEG-H 3D Audio.
   (8)

The program according to (6), causing the processor to execute:
causing an imaging unit to image an ear of the user and generate imaging data;
causing the imaging data to be output to a server allowed to generate the head-related transfer function; and
causing the first sound signal optimized for the ear of the user based on the imaging data to be acquired from the server.
   (9)

A control device comprising:
a first acquisition unit that acquires a first sound signal;
an output unit that outputs, to a user, the first sound signal and a second sound signal obtained by applying a hearing aid function to the first sound signal at different pieces of timing;
a second acquisition unit that acquires first hearing information of the user to the first sound signal and second hearing information of the user to the second sound signal; and
a generation unit that generates output data on wearing of a hearing aid of the user based on the first hearing information and the second hearing information.
   (10)

A hearing aid comprising:
the control device according to (9);
a sound collection unit that collects external sound and generates a voice signal; and
a signal processing unit that amplifies the voice signal.
   (11)

A communication device comprising:
the control device according to (9);
a communication unit allowed to communicate with a hearing aid; and
an imaging unit allowed to perform imaging.
   (12)

A hearing aid system comprising:
a hearing aid allowed to be worn by a user; and
a communication device allowed to communicate with the hearing aid,
wherein the communication device includes:
a first acquisition unit that acquires a first sound signal;
an output control unit that causes the hearing aid to output, to the user, the first sound signal and a second sound signal obtained by applying a hearing aid function to the first sound signal at different pieces of timing;
a second acquisition unit that acquires first hearing information of the user to the first sound signal and second hearing information of the user to the second sound signal; and
a generation unit that generates output data on wearing of a hearing aid of the user based on the first hearing information and the second hearing information.
   (13)

The hearing aid system according to (12),
wherein the output data is
an audiogram.
   (14)

The hearing aid system according to (12) or (13), further including
a decision unit that decides a parameter for hearing aid adjustment based on the output data.
   (15)

The hearing aid system according to (14),
wherein the parameter for hearing aid adjustment is
a gain for each frequency.
   (16)

The hearing aid system according to any one of (12) to (15),
wherein the first sound signal is
an inspection sound signal for the user.
   (17)

The hearing aid system according to any one of (12) to (16), further including
a processing unit that causes the processor to execute
generating a sound signal in which a head-related transfer function optimized for the user is convolved,
wherein the first sound signal is
a sound signal in which the head-related transfer function is convolved.
   (18)

The hearing aid system according to any one of (12) to (17),
wherein the first sound signal is
a signal based on MPEG-H 3D Audio.
   (19)

The hearing aid system according to (17), further including
an imaging control unit that causes an imaging unit to image an ear of the user and generate imaging data,
wherein the output control unit
causes the imaging data to be output to a server allowed to generate the head-related transfer function, and
the first acquisition unit
acquires, from the server, the first sound signal optimized for the ear of the user based on the imaging data.
   (20)

A control method to be executed by a control device including a processor, the control method comprising,
by the processor, executing:
acquiring a first sound signal;
outputting, to a user, the first sound signal and a second sound signal obtained by applying a hearing aid function to the first sound signal at different pieces of timing;
acquiring first hearing information of the user to the first sound signal and second hearing information of the user to the second sound signal; and
generating output data on wearing of a hearing aid of the user based on the first hearing information and the second hearing information.
   (21)

The control method according to (20),
wherein the output data is
an audiogram.
   (22)

The control method according to (20) or (21), including,
by the processor,
executing deciding a parameter for hearing aid adjustment based on the output data.
   (23)

The control method according to (22),
wherein the parameter for hearing aid adjustment is
a gain for each frequency.
   (24)

The control method according to any one of (20) to (23),
wherein the first sound signal is
an inspection sound signal for the user.
   (25)

The control method according to any one of (20) to (24), including,
by the processor,
executing generating a sound signal in which a head-related transfer function optimized for the user is convolved,
wherein the first sound signal is
a sound signal in which the head-related transfer function is convolved.
   (26)

The control method according to any one of (20) to (25),
wherein the first sound signal is
a signal based on MPEG-H 3D Audio.
   (27)

The control method according to (25), including,
by the processor, executing:
causing an imaging unit to image an ear of the user and generating imaging data;
outputting the imaging data to a server allowed to generate the head-related transfer function; and
acquiring, from the server, the first sound signal optimized for the ear of the user based on the imaging data.

### REFERENCE SIGNS LIST

1 HEARING AID SYSTEM
2 HEARING AID
3 CHARGING DEVICE
4 COMMUNICATION DEVICE
5 SERVER
20 SOUND COLLECTION UNIT
21 SIGNAL PROCESSING UNIT
22 OUTPUT UNIT
23 CLOCKING UNIT
24 OPERATION UNIT
25 BATTERY
26 CONNECTION UNIT
27, 34, 42 COMMUNICATION UNIT
28, 35, 46 RECORDING UNIT
29 HEARING AID CONTROL UNIT
31, 45 DISPLAY UNIT
32 BATTERY
33 HOUSING UNIT
36 CHARGE CONTROL UNIT
41 INPUT UNIT
43 IMAGING UNIT
44 OUTPUT UNIT
47 DEVICE CONTROL UNIT
201 MICROPHONE
202 A/D CONVERTER
221 D/A CONVERTER
222 RECEIVER
281, 351, 461 PROGRAM RECORDING UNIT
331 CONNECTION UNIT
462 HEARING MEASUREMENT RESULT RECORDING UNIT
471 IMAGING CONTROL UNIT
472 FIRST ACQUISITION UNIT
473 PROCESSING UNIT
474 OUTPUT CONTROL UNIT
475 SECOND ACQUISITION UNIT
476 GENERATION UNIT
477 DETERMINATION UNIT
478 DECISION UNIT
479 DISPLAY CONTROL UNIT
NW NETWORK
P1 HEARING MEASUREMENT SCREEN
P2 HEARING MEASUREMENT RESULT SCREEN

1. A program to be executed by a control device including a processor, the program causing the processor to:
acquire a first sound signal;
output, to a user, the first sound signal and a second sound signal obtained by applying a hearing aid function to the first sound signal at different pieces of timing;
acquire first hearing information of the user to the first sound signal and second hearing information of the user to the second sound signal; and
generate output data on wearing of a hearing aid of the user based on the first hearing information and the second hearing information.

2. The program according to claim 1,
wherein the output data is
an audiogram.

3. The program according to claim 1,
wherein the processor
decides a parameter for hearing aid adjustment based on the output data.

4. The program according to claim 3,
wherein the parameter for hearing aid adjustment is
a gain for each frequency.

5. The program according to claim 1,
wherein the first sound signal is
an inspection sound signal for the user.

6. The program according to claim 1, causing the processor to execute
generating a sound signal in which a head-related transfer function optimized for the user is convolved,
wherein the first sound signal is
a sound signal in which the head-related transfer function is convolved.

7. The program according to claim 1,
wherein the first sound signal is
a signal based on MPEG-H 3D Audio.

8. The program according to claim 6, causing the processor to execute:
causing an imaging unit to image an ear of the user and generate imaging data;
causing the imaging data to be output to a server allowed to generate the head-related transfer function; and
causing the first sound signal optimized for the ear of the user based on the imaging data to be acquired from the server.

9. A control device comprising:
a first acquisition unit that acquires a first sound signal;
an output unit that outputs, to a user, the first sound signal and a second sound signal obtained by applying a hearing aid function to the first sound signal at different pieces of timing;
a second acquisition unit that acquires first hearing information of the user to the first sound signal and second hearing information of the user to the second sound signal; and
a generation unit that generates output data on wearing of a hearing aid of the user based on the first hearing information and the second hearing information.

10. A hearing aid comprising:
the control device according to claim 9;
a sound collection unit that collects external sound and generates a voice signal; and
a signal processing unit that amplifies the voice signal.

11. A communication device comprising:
the control device according to claim 9;
a communication unit allowed to communicate with a hearing aid; and
an imaging unit allowed to perform imaging.

12. A hearing aid system comprising:
a hearing aid allowed to be worn by a user; and
a communication device allowed to communicate with the hearing aid,
wherein the communication device includes:
a first acquisition unit that acquires a first sound signal;
an output control unit that causes the hearing aid to output, to the user, the first sound signal and a second sound signal obtained by applying a hearing aid function to the first sound signal at different pieces of timing;
a second acquisition unit that acquires first hearing information of the user to the first sound signal and second hearing information of the user to the second sound signal; and
a generation unit that generates output data on wearing of a hearing aid of the user based on the first hearing information and the second hearing information.

13. A control method to be executed by a control device including a processor, the control method comprising,
by the processor, executing:
acquiring a first sound signal;
outputting, to a user, the first sound signal and a second sound signal obtained by applying a hearing aid function to the first sound signal at different pieces of timing;
acquiring first hearing information of the user to the first sound signal and second hearing information of the user to the second sound signal; and
generating output data on wearing of a hearing aid of the user based on the first hearing information and the second hearing information.
